(19) United States
(12) Patent Application Publication
(10) Pub. No.: US 2025/0289525 A1
(43) Pub. Date: Sep. 18, 2025

(54) SHOCK-ABSORBING SEAT POST STRUCTURE

(71) Applicant: Chao-Hu Chen, Taichung City (TW)

(72) Inventor: Chao-Hu Chen, Taichung City (TW)

(21) Appl. No.: 18/603,227

(22) Filed: Mar. 13, 2024

(51) Int. Cl. B62J 1/08; B62J 1/06

(52) U.S. Cl. CPC B62J 1/08; B62J 1/06

(57) ABSTRACT

A shock-absorbing seat post structure includes a shock-absorbing seat post having one of two ends thereof connected to a seat rod, another one of the two ends forming a seat tube. Two clamping portions extending from the seat tube. Each of the two clamping portions having an inwardly facing groove. The grooves of the two clamping portions form a mounting channel with an angle relative to the seat tube. The angle being less than 45 degrees. The grooves of the two clamping portions have an insertion opening at one of two ends thereof, and a stop portion is formed at another one of the two ends of the grooves. The bicycle frame is partially located within the mounting channel. The bicycle frame defines a horizontal line, and the seat tube intersects the horizontal line at 90 degrees.

### FIELD OF THE INVENTION

The present invention relates to a shock-absorbing seat post structure, which is installed on the bicycle frame to provide cushioning function for the seat.

### BACKGROUND OF THE INVENTION

Bicycles are a highly excellent mode of transportation, with their kinetic energy derived from human pedaling, making them environmentally friendly, and suitable for commuting, racing, sports, and other purposes. Each component of a bicycle is crucial, whether it be for pursuing comfort in riding, stability of the bicycle frame, competitive capabilities, etc., the quality and structure of each component must be pursued.

As for cyclists, the seat is a vital component that determines whether they can ride for extended periods. Apart from specialty models, most bicycles are equipped with seats. To cope with rough terrain (e.g., off-road cycling), riders often prefer seats with a certain degree of shock-absorbing capability to ensure comfort while riding. Therefore, most riders choose models with shock absorbers beneath the seat or modify their bicycles with relevant shock-absorbing equipment.

However, in the majority of commercially available models, due to the stability requirements of the bicycle frame, the bicycle frame beneath the seat generally forms a non-90-degree angle with the road surface. Consequently, when installing shock absorbers, the internal shock-absorbing components operate at an incline rather than vertically. This can easily lead to wear on various parts of the shock absorber (especially at the ends), resulting in a decrease in product lifespan.

There is a need to improve traditional shock absorbers used for bicycles, which are constrained by the angle of the bicycle frame, thereby causing issues with the operating direction of internal shock-absorbing components that are prone to wear.

The present invention intends to provide a shock-absorbing seat post structure to eliminate the shortcomings mentioned above.

### SUMMARY OF THE INVENTION

The present invention relates to a shock-absorbing seat post structure and comprises a shock-absorbing seat post having one of two ends thereof connected to a seat rod, and another one of the two ends forming a seat tube. Two clamping portions extend from the seat tube. Each of the two clamping portions has an inwardly facing groove that recesses away from each other. The grooves of the two clamping portions form a mounting channel with an angle relative to the seat tube. The angle is less than 45 degrees. The grooves of the two clamping portions have an insertion opening at one of two ends thereof, and a stop portion is formed at another one of the two ends of the grooves. Each clamping portion includes at least one locking hole.

Preferably, each clamping portion has two locking holes arranged linearly. Each clamping portion has a concave groove which is located away from the seat tube.

Preferably, each clamping portion has a raised portion formed to an outer side thereof and located corresponding to the groove corresponding thereto.

Preferably, the angle is between 14 degrees to 18 degrees.

The present invention also provides a shock-absorbing seat post structure which comprises a shock-absorbing seat post having one of two ends thereof connected to a seat rod, and another one of the two ends forming a seat tube. Two clamping portions extend from the seat tube. Each of the two clamping portions has an inwardly facing groove that recesses away from each other. The grooves of the two clamping portions form a mounting channel with an angle relative to the seat tube. The angle is less than 45 degrees. The grooves of the two clamping portions have an insertion opening at one of two ends thereof, and a stop portion is formed at another one of the two ends of the grooves. Each clamping portion includes at least one locking hole. The two clamping portions are clamped to a bicycle frame. A portion of the bicycle frame is located within the mounting channel. The bicycle frame defines a horizontal line, and the seat tube intersects the horizontal line at 90 degrees.

Preferably, each clamping portion has two locking holes arranged linearly. Each clamping portion has a concave groove which is located away from the seat tube.

Preferably, each clamping portion has a raised portion formed to an outer side thereof and located corresponding to the groove corresponding thereto.

Preferably, the angle is between 14 degrees to 18 degrees.

The two clamping portions extend from the seat tube to secure the bicycle frame. The mounting channel formed between the two clamping portions and the main body portion has an angle. Consequently, even when the invention is fixed to a bicycle frame with an inclined angle, the seat tube remains perpendicular to the ground. This eliminates the problem of the operating direction of the internal shock-absorbing components being inclined rather than vertical. Compared to traditional products, the invention effectively addresses the issues present in traditional products.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view of the shock-absorbing seat post structure of the present invention;

FIG. 2 is a plan view schematic diagram of the shock-absorbing seat post structure of the present invention;

FIG. 3 is a sectional view taken along line III-III of FIG. 2;

FIG. 4 is a schematic diagram of the actual use of the present invention, and

FIG. 5 is a partial schematic diagram of the actual use of the present invention.

### DETAILED DESCRIPTION OF THE PREFERRED EMBODIMENT

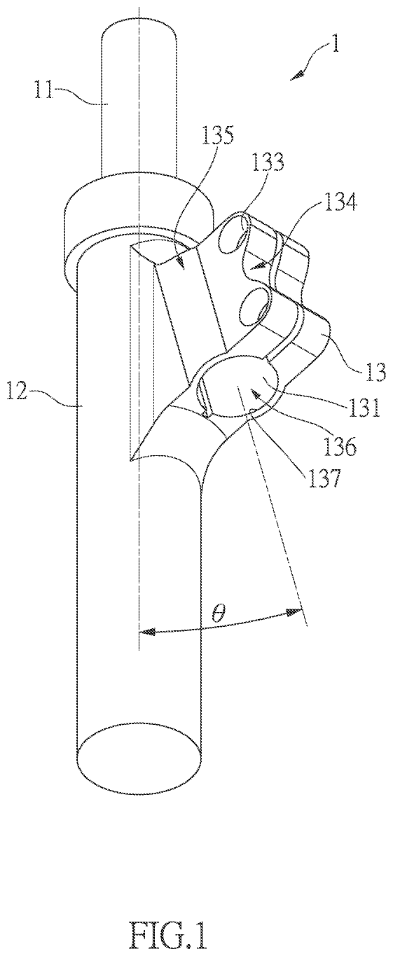

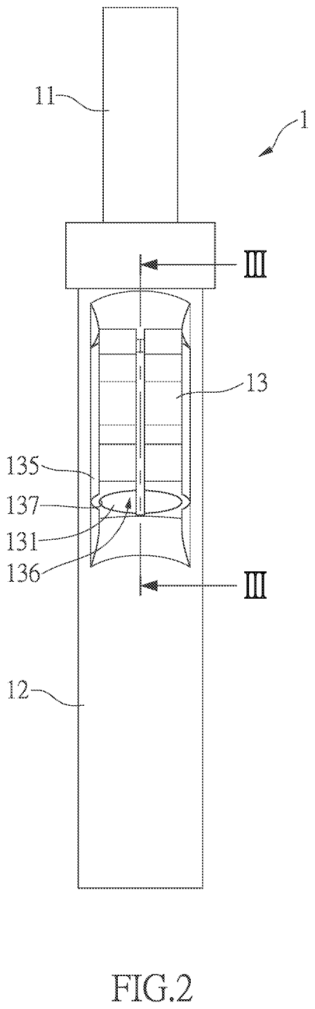

Referring to FIGS. 1-3, the shock-absorbing seat post structure of the present invention comprises a shock-absorbing seat post (1) having one of two ends thereof connected to a seat rod (11), and another one of the two ends forming a seat tube (12). Two clamping portions (13) extend from the seat tube (12). Each of the two clamping portions (13) has an inwardly facing groove (131) that recesses away from each other, the grooves (131) of the two clamping portions (13) forming a mounting channel (136) with an angle (θ) relative to the seat tube (12). The angle (θ) is less than 45 degrees. The grooves (131) of the two clamping portions (13) have an insertion opening (137) at one of two ends thereof, and a stop portion (132) is formed at another one of the two ends of the grooves (131). Each clamping portion (13) includes at least one locking hole (133).

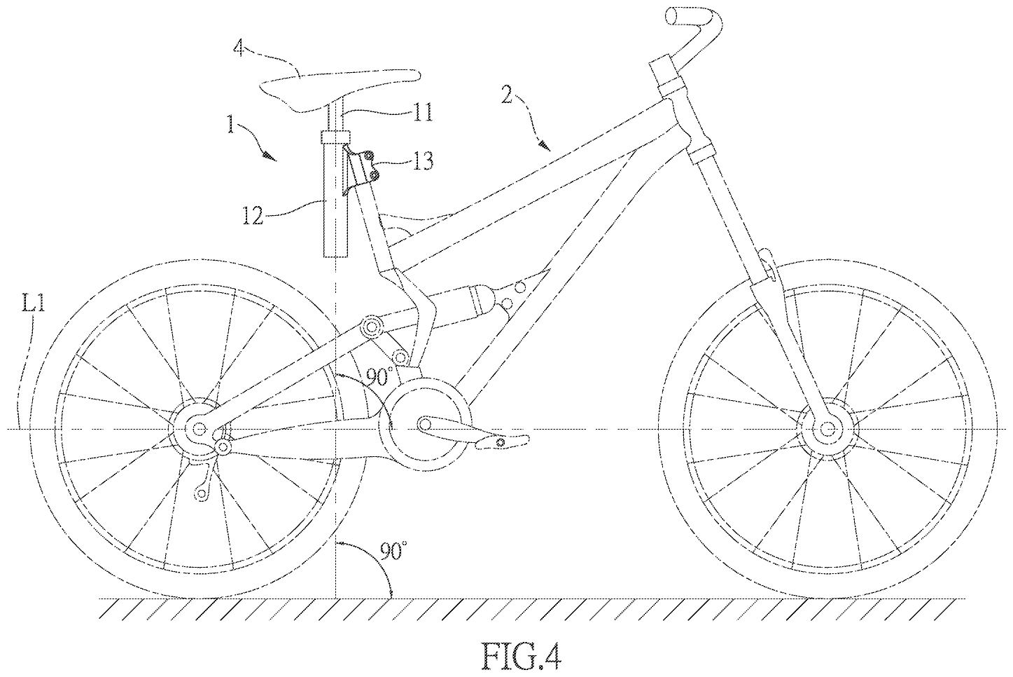

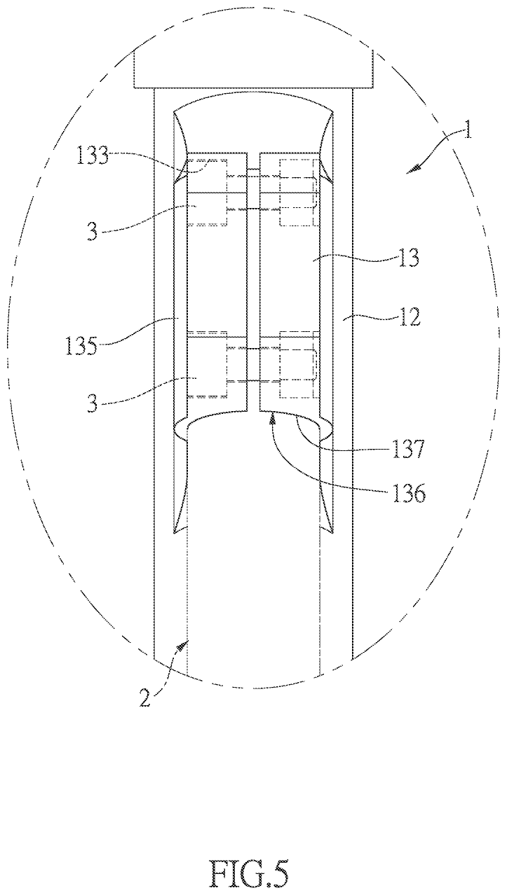

As shown in FIGS. 4 and 5, when installing the seat tube (12) to a bicycle frame (2), the two clamping portions (13) are clamped to the bicycle frame (2) by extending bolts through the locking holes (133) of the two clamping portions (13), to secure the seat tube (12) to the bicycle frame (2). A seat (4) is connected to the seat rod (11). A portion of the bicycle frame (2) is located within the mounting channel (136). As shown in FIG. 4, the bicycle frame (2) defines a horizontal line (L1), and the seat tube (12) intersects the horizontal line (L1) at 90 degrees. In this embodiment, the horizontal line (L1) passing through the two respective centers of the front and rear wheels of the bicycle frame (2). The seat tube (12) remains perpendicular to the ground so that the present invention eliminates the problem of the operating direction of the internal shock-absorbing components being inclined rather than vertical.

As shown in FIG. 1, each clamping portion (13) has two locking holes (133) arranged linearly. Each clamping portion (13) has a concave groove (134) which is located away from the seat tube (12). The concave grooves (134) aid users in better grasping the present invention so as to facilitate easier installation on the bicycle frame (2).

Furthermore, as shown in FIG. 1, each clamping portion (13) has a raised portion (135) formed on the outer side corresponding to its own groove (131). This structure prevents the thickness of the clamping portion (13) at the portion with the groove (131) from being too thin, thereby enhancing structural strength and increasing product lifespan.

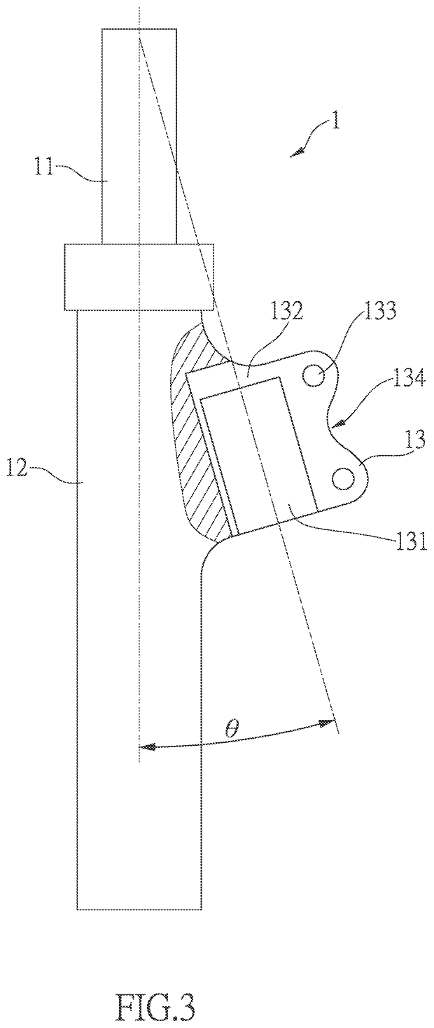

As shown in FIGS. 1 and 3, the angle (θ) mentioned above is between 14 degrees to 18 degrees (14 degrees, 15 degrees, 16 degrees, 17 degrees), with 16 degrees being used as an example in this embodiment.

While we have shown and described the embodiment in accordance with the present invention, it should be clear to those skilled in the art that further embodiments may be made without departing from the scope of the present invention.

What is claimed is:

1. A shock-absorbing seat post structure comprising:
a shock-absorbing seat post (1) having one of two ends thereof connected to a seat rod (11), another one of the two ends forming a seat tube (12), two clamping portions (13) extending from the seat tube (12), each of the two clamping portions (13) having an inwardly facing groove (131) that recesses away from each other, the grooves (131) of the two clamping portions (13) forming a mounting channel (136) with an angle (θ) relative to the seat tube (12), the angle (θ) being less than 45 degrees, the grooves (131) of the two clamping portions (13) having an insertion opening (137) at one of two ends thereof, a stop portion (132) formed at another one of the two ends of the grooves (131), each clamping portion (13) including at least one locking hole (133).

2. The shock-absorbing seat post structure as claimed in claim 1, wherein each clamping portion (13) has two locking holes (133) arranged linearly, each clamping portion (13) has a concave groove (134) which is located away from the seat tube (12).

3. The shock-absorbing seat post structure as claimed in claim 1, wherein each clamping portion (13) has a raised portion (135) formed to an outer side thereof and located corresponding to the groove (131) corresponding thereto.

4. The shock-absorbing seat post structure as claimed in claim 1, wherein the angle (θ) is between 14 degrees to 18 degrees.

5. A shock-absorbing seat post structure comprising:
shock-absorbing seat post (1) having one of two ends thereof connected to a seat rod (11), another one of the two ends forming a seat tube (12), two clamping portions (13) extending from the seat tube (12), each of the two clamping portions (13) having an inwardly facing groove (131) that recesses away from each other, the grooves (131) of the two clamping portions (13) forming a mounting channel (136) with an angle (θ) relative to the seat tube (12), the angle (θ) being less than 45 degrees, the grooves (131) of the two clamping portions (13) having an insertion opening (137) at one of two ends thereof, a stop portion (132) formed at another one of the two ends of the grooves (131), each clamping portion (13) including at least one locking hole (133), the two clamping portions (13) clamped to a bicycle frame (2), a portion of the bicycle frame (2) located within the mounting channel (136), the bicycle frame (2) defining a horizontal line (L1), the seat tube (12) intersecting the horizontal line (L1) at 90 degrees.

6. The shock-absorbing seat post structure as claimed in claim 5, wherein each clamping portion (13) has two locking holes (133) arranged linearly, each clamping portion (13) has a concave groove (134) which is located away from the seat tube (12).

7. The shock-absorbing seat post structure as claimed in claim 5, wherein each clamping portion (13) has a raised portion (135) formed to an outer side thereof and located corresponding to the groove (131) corresponding thereto.

8. The shock-absorbing seat post structure as claimed in claim 5, wherein the angle (θ) is between 14 degrees to 18 degrees.
